(19) United States
(12) Patent Application Publication
(10) Pub. No.: US 2023/0160442 A1
(43) Pub. Date: May 25, 2023

(54) Reduced shifting inertia continuously variable transmission clutch

(71) Applicant: Paul Van Metre, Eagle, ID (US)

(72) Inventor: Paul Van Metre, Eagle, ID (US)

(21) Appl. No.: 17/993,673

(22) Filed: Nov. 23, 2022

Related U.S. Application Data
(60) Provisional application No. 63/282,541, filed on Nov. 23, 2021.

(51) Int. Cl. F16C 19/30

(52) U.S. Cl. CPC F16C 19/30; F16C 2361/43

(57) ABSTRACT

A clutch for a continuously variable transmission which reduces friction between moving parts by adding bearings at points of contact between the movable sheave and weights and between rollers and the spider.

### CROSS-REFERENCE TO RELATED APPLICATIONS

This application claims priority to provisional application 63/282,541 filed on Nov. 23, 2022.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

Continuously variable transmissions (CVT) are commonly used in light-weight vehicles such as all-terrain vehicles and snow mobiles. Clutches for CVTs operate by having a stationary sheave and a movable sheave. When the clutch is not spinning, the sheaves are at their maximum distance apart and the belt is at its point nearest the hub of the clutch. As the clutch spins faster, momentum acts on weights in the clutch causing them to spin out. As the weights spin out, they exert force on the back of the movable sheave forcing the movable sheave toward the stationary sheave. As the movable sheave moves toward the stationary sheave, the clutch belt is forced up the face of the sheaves into a “higher” gear to a point where the sheave faces are a minimal distance apart. As the speed of the clutch decreases, springs in the clutch push the movable sheave away from the stationary sheave. As the movable sheave moves away from the stationary sheave, the clutch belt moves toward the hub of the clutch placing the transmission in a “lower” gear.

The performance characteristics of a CVT may be adjusted by changing the spring weight on the movable sheave. A heavier spring will require a higher RPM for the transmission to shift to a higher gear. Conversely, a lower spring will permit the transmission to shift to a higher gear at a lower speed. Heavier weights will shift the transmission to a higher gear at a lower RPM. Conversely, lighter weights will require a higher RPM to shift the shift the transmission to a given gear. Different weight shapes, and distributing portions the weight differently along the length of the weight, can also alter the performance characteristics of a CVT.

CVT clutches are mechanically quite simple, but many CVT clutches require maintenance at relatively short intervals (often in under 500 miles). If a CVT clutch has not been shifting smoothly, the sheaves may become grooved which can exponentially increase performance degradation of the CVT clutch. Weights are installed on pins to permit them to rotate out and in due to momentum. The pins are geometrically positioned as chords about the rotating shaft. Friction between the on the weights and the pins can cause the weights to not move as easily as would be desirable resulting “sticky” shifting. Bushings are often installed between the weight and the pin on which the weight is installed. Bushings may also installed between the weight and the arms of the “spider.” These bushings decrease wear of the weight on the arms and pin.

### DESCRIPTION OF RELATED ART INCLUDING INFORMATION DISCLOSED UNDER 37 CFR 1.97 AND 37 CFR 1.98

Not Applicable

### BRIEF SUMMARY OF THE INVENTION

A clutch for a continuously variable transmission which reduces friction between moving parts by adding bearings at points of contact between the movable sheave and weights and between rollers and the spider.

### BRIEF DESCRIPTION OF THE SEVERAL VIEWS OF THE DRAWING

FIG. 1 shows a clutch spider of the present invention.

FIG. 2 shows a roller bearing.

FIG. 3 shows a thrust needle bearing.

FIG. 4 shows clutch weights.

FIG. 5 shows a clutch weight pin.

FIG. 6 shows a movable sheave.

FIG. 7 shows a spacer of the present invention.

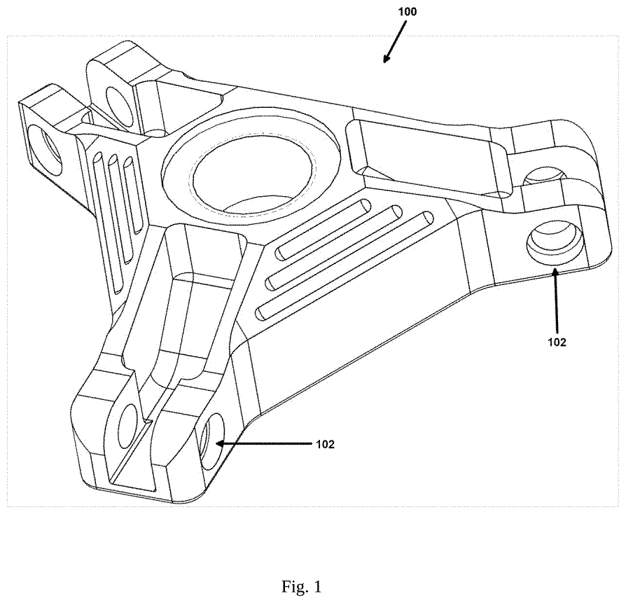

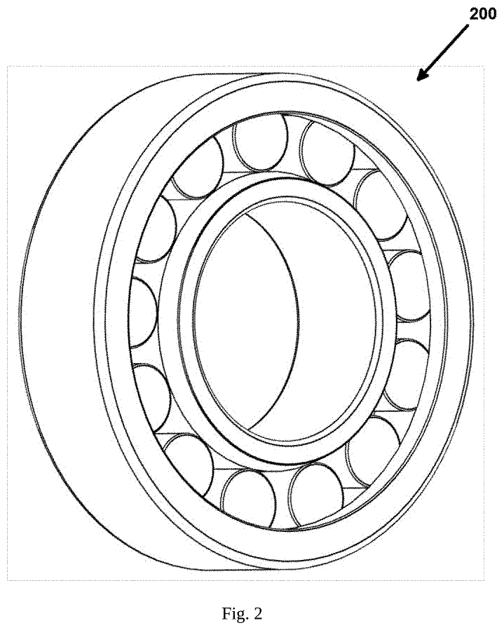

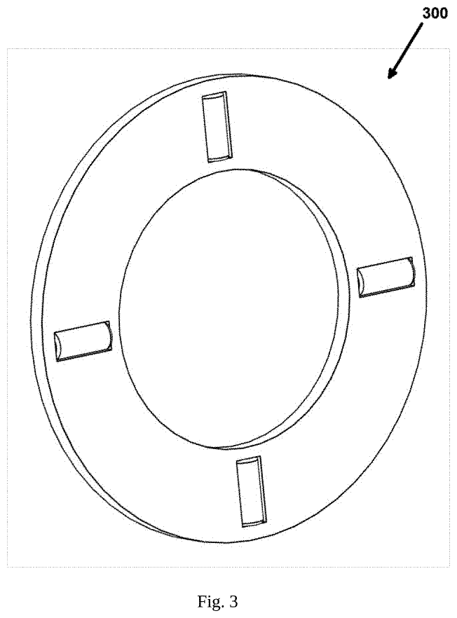

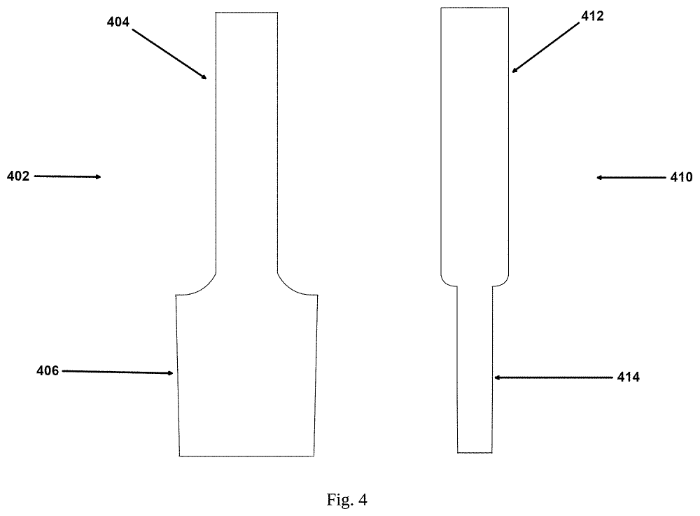

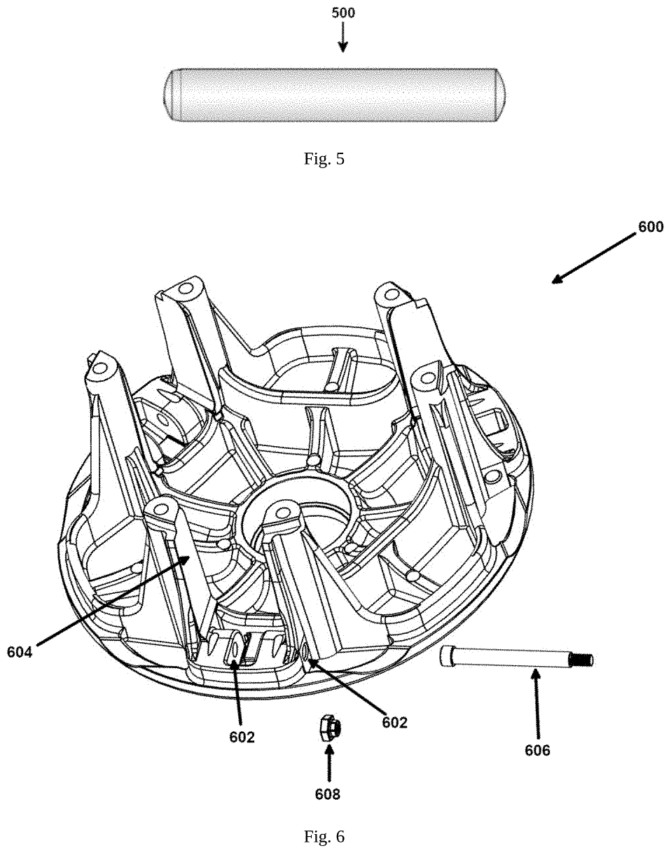

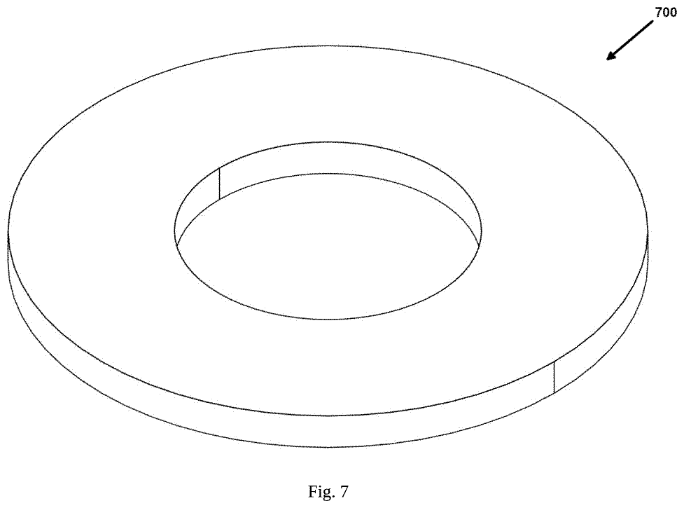

### DETAILED DESCRIPTION OF THE INVENTION

The applicant's invention is a reduced friction primary clutch for a continuously variable transmission. Friction is reduced, and wear resistance is increased, by installing bearings at key locations. The applicant's improvement includes installing as many as 21 bearings in a primary clutch in various combinations of locations. Clutches are assembled symmetrically since they spin at high speed and balance is critical. Generally, primary clutches have 3 sets of features, though other sets of features are within the scope of the applicant's inventions.

In prior art clutches, roller bushing pins are installed in spider arms. In prior art clutches, a spacer 700 is installed on both sides of a bushing in the arm opening between the roller bushing and the sides of the opening on the roller pin. In a preferred embodiment of the applicant's invention, a sealed roller bearing 200 is used in place of the roller bushing on the roller bushing pin 500. In a preferred embodiment of the applicant's invention, spacers 700 are installed between each side of the sealed roller bearing 200 and the insides of the opening of the arm. In a preferred embodiment, spacers 700 comprised of a low-friction polymer are used. In an alternative embodiment of the applicant's invention, thrust need bearings are used in place of spacers 700. In certain embodiments of the applicant's invention, the arms of the spider 100 are modified 102 to accommodate the installation of bearings. In a preferred embodiment, a roller bearing 200 is installed in the spider arm on both sides of the opening such that the roller pin 500 may rotate within the spider arm supported by the bearings.

In one embodiment of the applicant's invention, a bearing (clutch weight pin bearing) 200 is installed in the pin hole of each clutch weight 402. The clutch weight 402 is then installed in a movable sheave 600. In a preferred embodiment, the clutch weight pin bearing 200 is a sealed roller bearing.

A conventional movable sheave is configured with two holes, adjacent each weight, to accommodate a bolt or pin, onto which a clutch weight 402 is installed. In one embodiment of the applicant's invention, bearings 200 are installed in these holes 602 in the movable sheave 600. In certain embodiments, the movable sheave is further configured with holes whereby the bearings in the movable sheave may be lubricated.

In one embodiment of the applicant's invention, these spacers 700 are replaced with thrust needle bearings 300. Certain clutch weights 402 are wider adjacent the pin hole 406 than where they contact the movable sheave 404. The width of the clutch weight 410 may also be reduced 414, at least adjacent the pin hole, if necessary to account for any increased thickness of the needle thrust bearings 300 compared to the width of the spacer(s) 700 while leaving the portion 412 which contacts the movable sheave unaltered. In certain prior art clutches spacers are not installed between the weight 402 and the movable sheave 600. In these configurations, the width of the clutch weight 410 may also be reduced (at least adjacent the pin hole) 414 to accommodate the width of the thrust roller bearings 300. In a preferred embodiment, needle thrust bearings 300 are installed on.

A movable sheave 600 is configured with two holes 602, adjacent an opening 604. A clutch weight 402 is installed in the opening. The clutch weight 402 is held in place by a bolt or pin 606 passing through the holes 602 and through a pin hole in the clutch weight. In the case of a bolt 606, a nut 608 is preferably installed on the bolt 606. In a conventional movable sheave 600, spacers 700 may be installed on either side of the clutch weight 402 between the clutch weight and the sides of the opening 604 in the movable sheave 600. In one embodiment of the applicant's invention, the spacers 700 on either side of the clutch weight 402 are replaced by thrust needle bearings 300. In a preferred embodiment, the holes 602 adjacent the opening 604 are configured to accommodate roller bearings 200. In a preferred embodiment, the width of the clutch weight 410 is reduced adjacent the pin hole 414 in the clutch weight. The width of the clutch weight contacting the spider 412 is preferably unchanged. In an alternative embodiment of the applicant's invention, a roller bearing is installed in the clutch weight pin hole between the clutch weight and the bolt or pin on which the clutch weight is installed. In certain embodiments, the movable sheave 600 is configured with a plurality of orifices through which lubricant may be passed to lubricate roller bearings installed in the movable sheave 600.

In certain embodiments, bearings are installed in the spider to reduce friction between the weights and the spider. In a conventional spider, a bushing is installed in the weight opening of the spider on a pin or bolt each arm of the spider. A bushing is used to reduce friction between the weight and the spider and because the weight contacts the spider at slightly different points as the clutch RPM changes. Because the bushing must rotate on the pin, a significant gap generally exists between the bushing and pin. In a preferred embodiment of the applicant's invention, an inner bearing 200 is installed in the spider arm replacing a bushing of a conventional clutch. Replacing the bushing with a bearing in the present invention allows the bearing to be installed with little gap (even a force fit between the pin and inner bearing in certain embodiments) between the pin and bearing. The reduced gap results in decreased pin wear because the bearing will remain more coaxial with the pin than with a conventional configuration using a bushing. In an alternative embodiment, more than on bearing 200 is installed on the pin between the ridges of the spider arm. Using multiple bearings can decrease over-all weight, thereby reducing inertial momentum, and reduce surface contact area between the weights and the spider.

In certain embodiments, outer bearings 200 are installed in the arms 201 of the spider. In this embodiment, the outer bearings are installed between the pin and ridge of the spider which holds the pin supporting either the bushing of a conventional clutch spider or the pin supporting the bearing of the present improved clutch spider. In various combinations the outer bearings may be used, the inner bearing may be used, or all may be used together within the scope of the present invention.

For purposes of this disclosure, including claims, plurality means one or more unless otherwise explicitly indicated.

1. A clutch apparatus comprising:
A) a movable sheave, and
B) a plurality of clutch weight assemblies comprising:
I) a clutch weight pivot installed in said movable sheave,
II) a clutch weight pivot bearing installed on said clutch weight pivot, and
III) a clutch weight installed on said clutch weight pivot bearing.

2. The clutch apparatus of claim 1 wherein:
A) said clutch weight pivot bearing is a roller bearing pin.

3. The clutch apparatus of claim 1 further comprising:
A) a plurality of inner bearings disposed on said clutch weight pivot between said clutch weight and said movable sheave.

4. The clutch apparatus of claim 3 wherein:
A) said plurality of inner bearings are thrust bearings.

5. The clutch apparatus of claim 3 further comprising:
A) a plurality of outer bearings disposed between said clutch weight pivot and said movable sheave.

6. The clutch apparatus of claim 1 further comprising:
A) a plurality of outer bearings disposed between said clutch weight pivot and said movable sheave.

7. The clutch apparatus of claim 6 wherein:
A) said outer bearings are roller bearings.

8. The apparatus of claim 7 further comprising:
A) a plurality of orifices in said movable sheave terminating at the outer bearings configured to accept outer bearing lubricant through said orifices.

9. A clutch apparatus comprising:
A) a clutch spider having a plurality of openings, and
B) a plurality of clutch weight roller assemblies comprising:
I) a plurality of clutch weight roller pivot installed in said clutch spider,
II) a clutch weight roller bearing installed on said clutch weight roller pivot in an opening in said clutch spider.

10. The apparatus of claim 9 further comprising:
A) a plurality of inner bearings disposed on said clutch weight roller pivot between said clutch weight roller bearing and inner edges of an opening in said clutch spider.

11. The apparatus of claim 10 wherein:
A) said plurality of inner bearings are thrust needle bearings.

12. The clutch apparatus of claim 9 further comprising:
A) a plurality of spacers disposed on said clutch weight roller pivot between said clutch weight roller pin bearing and inner edges of an opening in said clutch spider.

13. The clutch apparatus of claim 12 wherein:
A) said plurality of spacers are comprised of a polymer having a low coefficient of friction.

14. The clutch apparatus of claim 11 further comprising:
A) a plurality of outer bearings installed in clutch spider disposed between said clutch spider and said clutch weight roller pivot.

15. The clutch apparatus of claim 14 wherein:
A) said plurality of outer bearings are roller bearings.

16. The apparatus of claim 14 further comprising:
A) a plurality of orifices in said clutch spider terminating at the outer bearings configured to accept outer bearing lubricant through said orifices.

17. A clutch weight having a width which is less adjacent a pivot point of the clutch weight than at a surface configured to contact a clutch spider.
